(19) United States
(12) Patent Application Publication
(10) Pub. No.: US 2004/0099643 A1
(43) Pub. Date: May 27, 2004

(54) Higher-power laser welding installation

(76) Inventors: Remy Fabbro, Antony (FR); Frederic Coste, Paris (FR); Lilian Sabatier, Lavars (FR); Jean-Pierre Billon, Villenueve St Georges (FR)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/471,288

(22) PCT Filed: Mar. 22, 2002
(86) PCT No.: PCT/FR02/01009

(30) Foreign Application Priority Data
Mar. 26, 2001 (FR) 01/04030

(51) Int. Cl. B23K 26/24; B23K 26/14

(52) U.S. Cl. 219/121.63; 219/121.84

(57) ABSTRACT

Gas is blown to protect the weld area (14) by means of a ring nozzle (6) open at the top so as to allow centripetal flow of the gas, deviated by weld work pieces (4, 5), and which then turns back towards the top of the nozzle completing the purge of all ambient gas.

The subject of this invention is a high power laser welding installation.

This type of welding requires the supply of a shielding gas over the weld area to facilitate the formation of an interaction plasma, in particular to eliminate the phenomenon of disruption or to protect the weld pool by preventing it from oxidizing or undergoing other chemical deterioration. A conventional solution consists of placing a tube leading to a supply source of the gas to be provided, whose end is directed towards the weld area. In general, the axis of this tube is placed along the plane defined by the axis of the laser beam and the direction of weld bead, forming an angle which may be approximately 456° relative to the axis of the beam. While this arrangement is of interest for welding a rectilinear weld bead, this is not the case for welding in a curved line or in three-dimensional space. Since the axis of the nozzle no longer lies in the previously defined plane, the quality of the gas shield is no longer constant along the length of the bead. It is to avoid these disadvantages that it has again be proposed to use shield boxes which are pierced to allow the ray to pass, which cover a large region around the weld zone area in which a shielding gas is injected. Such boxes generally bear upon the surface to be protected and cannot therefore be moved, since they are not integral with the welding head. Such an installation is not practical to use and is only suitable for horizontal surfaces.

The purpose of the invention is to guarantee the formation of the gas medium of desired composition over the weld area. More precisely, the invention in its more general form relates to a high power welding installation comprising a laser beam and means for blowing gas over the weld area, characterized in that said means comprise a ring nozzle, integral with the laser and designed so that it generates a laminar flow of gas so that part of the gas is evacuated via a base of the nozzle, radially around a focusing zone of the laser beam and towards the outside, and so that another part of the gas flows back inside a region surrounded by the nozzle and escapes towards the outside via an open inlet face of the laser beam.

Therefore, the centripetal radial flow set up around the focusing zone of the laser beam enables the gas to flow back inside the ring area of the nozzle and to escape towards the outside via the open inlet face of the laser beam. Ambient gas is prevented from arriving at the weld area by this reflux of shielding gas. The centrifugal radial flow completes the protection of the weld area.

The invention will be described in more detail with some additional aspects in connection with the following figures:

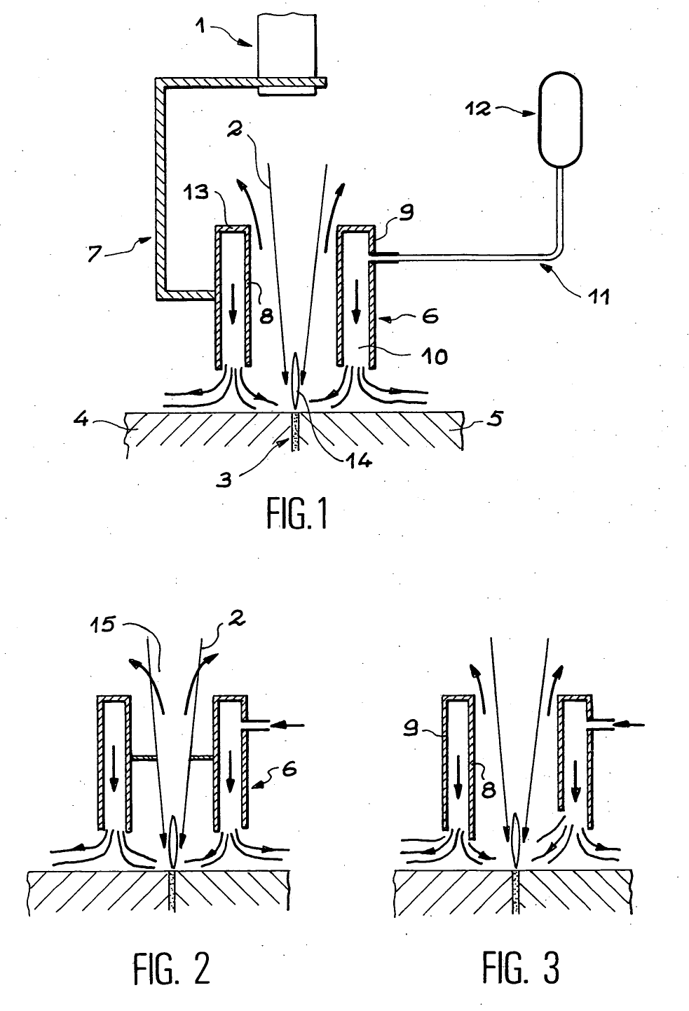

FIG. 1 is a general view of the invention, and

FIGS. 2 to 6 illustrate some possible variants.

The weld installation in FIG. 1 comprises a laser 1 which emits a ray or beam 2 towards a weld joint 3 defined between two work pieces 4 and 5 which may or may not be planar. The weld installation also comprises a nozzle 6 connected to laser 1 via a support head 7. Nozzle 6 is made up of an inner tube 8 and an outer tube 9, which are concentric and therefore define a ring-shaped chamber 10 between them and which are both parallel to the beam. A gas duct 11 derived from a source 12 leads into chamber 10, which is closed at the rear by a wall 13 but open at the base, towards pieces 4 and 5 so that the blown gas escapes from the chamber at this point in a laminar flow. It is deviated by work pieces 4 and 5, one portion flowing towards the outside and another towards the inside, in particular towards beam focusing region 14 where the plasma responsible for welding is formed. Subsequently, the gas having a centripetal movement rises inside inner tube 8 and escapes from nozzle 6 in counter flow to beam 2. This outgoing movement fully purges the inside of nozzle 6 of ambient gas; this is made possible by the absence of a focusing lens for beam 2 which may derive from a carbon gas laser 1 which has the property of emitting light at a wavelength for which lens component materials are fairly absorbent. Since the power must be high (10 kW for example), there is a risk that the lenses may be destroyed which accounts for the fact that they are usually dispensed with for such applications.

FIG. 2 however shows that the section of the upper opening of nozzle 6 can be reduced by adding a ring-shaped collar 15 which leaves clear a section corresponding to the section of beam 2, without jeopardizing evacuation of the gas or disturbing the purpose of the divergent flow at the exit of nozzle 6.

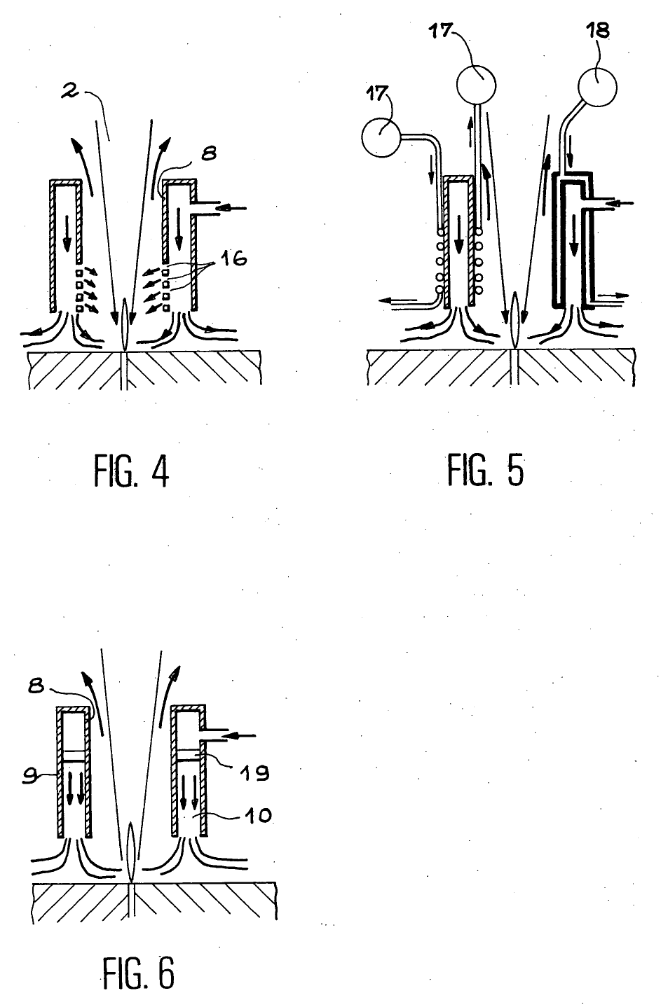

FIGS. 3 and 4 however show that this flow can be modified by making inner tube 8 either longer, or shorter than outer tube 9 (on the left and right halves of FIG. 3 respectively), which deviates the median flow of the gas at the exit of nozzle 6 in oblique fashion making unequal the proportions of gas deviated towards the inside and towards the outside. Another arrangement, shown in FIG. 4, consists of piercing holes at the bottom of one of the tubes, inner tube 8 in particular, in order to facilitate the flow of gas inside this tube and hence to increase the protection of the weld area.

Other modifications can be proposed: FIGS. 5 and 6 for example show that nozzle 6 can be cooled by placing heat exchange circuits 17 or 18 in the form of coils along tubes 8 or 9 or of channels made within these tubes; that a diffusing medium 19 can be placed in chamber 10 to homogenize the flow in both tubes 8 and 9. All these modifications and additions can evidently be accumulated at will.

1. High power weld installation comprising a beam (2) of a laser (1) and means (6) for blowing gas over a weld area (4,5;14), characterized in that said blowing means comprise a ring nozzle (6) integral with the laser and designed so as to generate a laminar gas flow such that part of the gas is evacuated via a base of the nozzle, radially around a focusing zone of the laser beam and towards the outside, and such that another part of the gas flows back inside a region surrounded by the nozzle and escapes towards the outside via an open inlet face of the laser beam.

2. Installation according to claim 1, characterized in that the nozzle is made up of an inner tube (8) and an outer tuber (9) which have lower edges directed towards the weld area, at different distances from the weld area.

3. Installation according to claim 1, characterized in that the nozzle is made up of an outer tube and an inner tube, and in that the inner tube is pierced (16) at a lower portion directed towards the weld area.

4. Installation according to any of claims 1 to 3, characterized in that the nozzle is cylindrical.

5. Installation according to any of claims 1 to 4, characterized in that the nozzle is crossed by a porous layer (19) diffusing the gas.
